(19) United States
(12) Patent Application Publication
(10) Pub. No.: US 2006/0220911 A1
(43) Pub. Date: Oct. 5, 2006

(54) Parking space detection method

(75) Inventors: Gaelle Jaupitre, Paris (FR); Antonio Vitale, Paris (FR); Cyril Hue, Moulineaux (FR)

Correspondence Address: SUGHRUE MION, PLLC, 2100 PENNSYLVANIA AVENUE, N.W., SUITE 800, WASHINGTON, DC, 20037, US

(73) Assignee: Alcatel

(21) Appl. No.: 11/362,916

(22) Filed: Feb. 28, 2006

(30) Foreign Application Priority Data
Feb. 28, 2005 (EP) 05290449.7

(51) Int. Cl. G08G 1/14

(52) U.S. Cl. 340/932.2

(57) ABSTRACT

The invention relates to a free parking space detection method comprising: a step of sending, from a user to a server, a free parking space request specifying a location; a step of image capture apparatus situated in the vicinity of the specified location capturing one or more images of a parking area comprising a plurality of parking spaces and being associated with the apparatus; an image processing step to determine respective lengths of free parking spaces in the parking area from one or more images of the parking area; a step of sending the server an identifier of the image capture apparatus and said respective lengths of said free parking spaces; and a step of sending, from a server to a user, at least one free parking space location.

The invention relates to the field of methods of detecting free parking spaces in parking areas to enable users to tell in advance whether a parking area has any free parking spaces enabling them to park their respective vehicles.

According to the prior art as described in international patent application WO 01/00448, using a video camera disposed to enable monitoring of the occupancy or non-occupancy of predetermined parking spaces is known in the art.

According to other prior art as described in British patent application GB 2247554, the conjoint use of a video camera and marks on the ground to determine free parking spaces in a parking area is known in the art.

According to further prior art as described in Dutch patent application NL 20001016474, using a video camera to detect whether parking spaces are free or occupied is known in the art.

According to further prior art as described in US patent applications 2004/0015290 and 2003/0074129, using a video camera to determine free or occupied spaces in a parking area by analyzing the variance of the image from the video camera is known in the art.

In all of the above prior art, the parking spaces are predetermined and the result of the analysis of the image of the parking area is binary, in other words for each predetermined parking space the result is either “space free” or “space occupied”. In the event of incorrect parking of a vehicle so that it straddles two parking spaces, the result will be incorrect; either a partially occupied parking space will be reported as being free or a free parking space straddling two predetermined spaces that are themselves partially occupied will not be reported as a free parking space.

The invention proposes a form of image processing that extracts free parking spaces and their respective lengths, whatever their disposition relative to the predetermined parking space markings; thus a free parking space straddling two predetermined parking spaces that are partially occupied will be identified, together with its length. Moreover, in the absence of markings on the ground, each continuous length of free parking space will be identified. The free parking spaces and their lengths will be used to indicate to a user a free parking space whose length is appropriate for him to be able to park his vehicle. At the same time, knowing the exact length of the available free parking space will enable the user, without wasting time attempting to park, to park without difficulty only in parking spaces appropriate to the length of his vehicle, and will enable the server to manage all available parking spaces in all parking areas more effectively by enabling optimum use of all available parking spaces.

Two main embodiments are envisaged. In the first embodiment, the length of the free parking space is communicated directly to the user who, knowing the length of his vehicle, decides directly whether the free parking space indicated by the server to the user by way of the location of said free parking space is suitable or not, in other words, if its length is sufficiently greater than the length of his vehicle to enable him to park correctly. In the second embodiment, the length of the vehicle, as supplied by the user either directly or indirectly through representative information, and the length of the free parking space are compared by the server itself, which then simply communicates to the user the location of the free parking space, after the server has verified the suitability of the latter space given the length of the user's vehicle; to this end, one option is for the user to elect a personalized minimum difference between the length of a free parking space and the length of his vehicle, which difference the user can select for himself on the server as a function of his personal skill at parking maneuvers.

According to the first main embodiment of the invention, there is provided a free parking space detection method comprising: a step of sending, from a user to a server, a free parking space request specifying a location; a step of image capture apparatus situated in the vicinity of the specified location capturing one or more images of a parking area comprising a plurality of parking spaces and being associated with the apparatus; an image processing step to determine respective lengths of free parking spaces in the parking area from one or more images of the parking area; a step of sending the server an identifier of the image capture apparatus and said respective lengths of said free parking spaces; and a step of sending, from a server to a user, at least one free parking space location and at least one length associated with said free parking space.

According to the first main embodiment of the invention, there are also provided a free parking space detection terminal used in the free parking space detection method of the first main embodiment of the invention and a free parking space detection device included in the free parking detection terminal of the first main embodiment of the invention. The invention also relates to a free parking space detection terminal comprising: image capture apparatus associated with a parking area comprising a plurality of parking spaces and adapted to capture images of said parking area; and a free parking space detection device comprising: an image processing module adapted to determine from one or more images captured by the image capture apparatus the respective lengths of the free parking spaces in the parking area; and an interface adapted to send an identifier of the image capture apparatus and said respective lengths of said free parking spaces to a server. The invention further relates to a free parking space detection device comprising: an image processing module adapted to determine from one or more images of a parking area comprising a plurality of parking spaces the respective lengths of the free parking spaces in the parking area; and an interface adapted to send an identifier of an image capture apparatus that supplied the image or images of the parking area and said respective lengths of said free parking spaces to a server.

According to the second main embodiment of the invention, there is provided a free parking space detection method comprising: a step of sending, from a user to a server, a free parking space request specifying a location and information representative of a vehicle length; a step of image capture apparatus situated in the vicinity of the specified location capturing one or more images of a parking area comprising a plurality of parking spaces and being associated with the apparatus; an image processing step to determine respective lengths of free parking spaces in the parking area from one or more images of the parking area; a step of sending the server an identifier of the image capture apparatus and said respective lengths of said free parking spaces; a step of the server comparing, on the one hand, one or more of said respective lengths and, on the other hand, the information representative of a vehicle length, selecting at least one free parking space having a length adapted to said information representative of a vehicle length; and a step of sending, from a server to a user, at least one selected free parking space location.

According to the second main embodiment of the invention, there are also provided a free parking space detection terminal used in the free parking space detection method of the second main embodiment of the invention and a free parking space detection device included in the free parking detection terminal of the second main embodiment of the invention. The invention also relates to a free parking space detection terminal comprising: image capture apparatus associated with a parking area comprising a plurality of parking spaces and adapted to capture images of said parking area; and a free parking space detection device comprising: an image processing module adapted to determine from one or more images captured by the image capture apparatus the respective lengths of the free parking spaces in the parking area; and an interface adapted to send an identifier of the image capture apparatus and said respective lengths of said free parking spaces to the server. The invention further relates to a free parking space detection device comprising: an image processing module adapted to determine from one or more images of a parking area comprising a plurality of parking spaces the respective lengths of the free parking spaces in the parking area; and an interface adapted to send an identifier of an image capture apparatus that supplied the image or images of the parking area and said respective lengths of said free parking spaces to a server.

Moreover, the second main embodiment of the invention further relates to the server cooperating with the free parking space detection terminal of the second main embodiment of the invention to implement the free parking space detection method of the second main embodiment of the invention. The invention further relates to a free parking space detection server comprising: a comparison module adapted to compare one or more respective free parking space lengths and information representative of a vehicle length supplied by a user, selecting at least one free parking space having a length adapted to said information representative of a vehicle length; and an interface adapted to send at least one selected free parking space location to a user.

The invention will be better understood and other particular features and advantages will become apparent in the light of the following description and from the appended drawings, which are provided by way of example, in which:

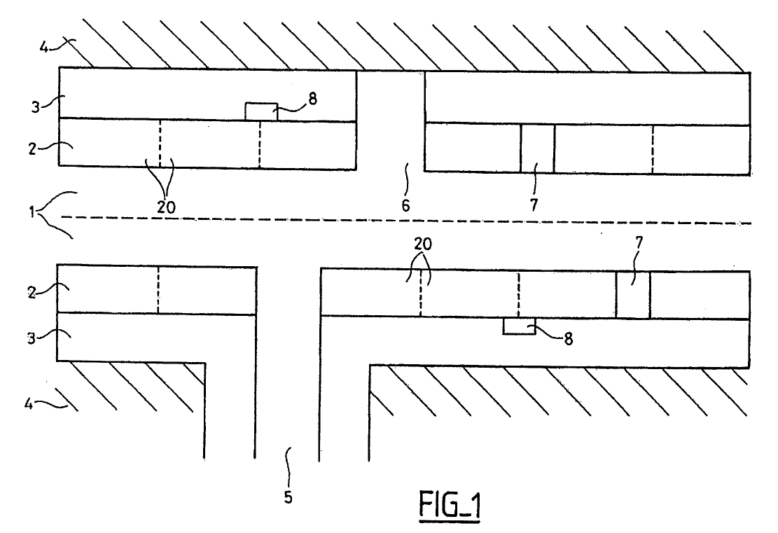

FIG. 1 is a diagram representing a parking area in which the free parking space detection method of the invention may be used;

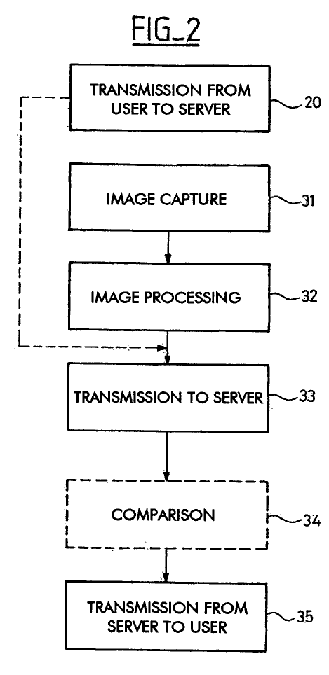

FIG. 2 is a diagram representing the sequence of steps of the free parking space detection method of the invention.

The parking area associated with a parking space detection terminal of the invention is preferably a parking area comprising a plurality of parking spaces disposed in one or more lines so that the lengths of the spaces are parallel to the line in which said spaces are disposed, each line being continuous or discontinuous and bordered on at least one side by a carriageway, the lengths of the parking spaces being parallel to the carriageway that borders the line in which said spaces are situated. The free parking space detection method of the invention is particularly well adapted to detecting parking spaces in that type of parking area. In practice, a routine example of the above type of parking area consists of parking spaces situated on one or both sides of a town or city street.

FIG. 1 is a diagram representing a parking area made up of parking spaces in which the free parking space detection method of the invention may be used, for example. On respective opposite sides of a carriageway 1 are two discontinuous lines 2 of parking spaces 20 bordered by pavements 3 bordered by dwellings 4. The lines 2 are discontinuous by virtue of the presence of obstacles, for example an adjoining street 5, a garage exit 6 or planters 7. The free parking space detection terminals 8 are preferably situated on the pavements 3 and may consist of street lamps to which a few additional functions are added. Accordingly, even at night, the illumination necessary for the imaging device of the detection terminal exists, as it is then provided by the illumination from the street light.

The imaging device is preferably either a video camera or a still camera capturing images relatively frequently. Image capture and processing are effected in the detection terminal, which sends the server only the result of image processing and not the images themselves, which would require too great a bandwidth of the resources of the telecommunication network connecting the detection terminals to the server. Sending of images for centralized image processing may nevertheless be envisaged, but would have much higher operating costs.

FIG. 2 is a diagram representing the sequence of steps of the free parking space detection method of the invention. An image capture step 31 is effected by image capture apparatus of the detection terminal. During this image capture step 31, the image capture apparatus captures one or more images of the parking area with which the image capture apparatus is associated. The detection device of the detection terminal then effects an image processing step 32. For example, the image processing step 32 comprises, in succession: an image analysis function differentiating between image areas corresponding to a parking space category and image areas corresponding to an occupied parking space category; a function of extracting the positions and the extents of at least one category of image areas; a calculation function for calculating at least one category of image areas, integrating perspective correction depending on the position and the extent of said image areas and the height above the ground of the image capture apparatus, and determining the respective free parking space lengths. In a time interval that begins before the image capture step 31 and terminates before the step 33 of sending to the server, there is effected the step 20 of the user sending to the terminal during which the user sends his request for a free parking space by specifying a location and, in the second main embodiment of the invention, also information representative of a vehicle length, which could be either the length of the vehicle as such, for example, or the vehicle model. Thereafter, a step 33 of sending to the server is effected. The detection terminal sends the server an identifier of the image capture apparatus that captured the image or images of the parking area with which it is associated in such a manner as to allow location of the parking area and the respective lengths of the free parking spaces of the parking area to enable them to be used by the server. In the first main embodiment of the invention, during the step 35 of sending from the server to the user that follows on from the step 33 of sending to the server, the server sends the user at least one free parking space location corresponding to the place specified by the user in his request, as well as the length of the free parking space. The server preferably sends one or more free parking space locations with a plurality of free parking space lengths to enable the user to make a choice as a function of his vehicle. If not, if the free parking space length(s) sent by the server are not adapted to the user's vehicle, the user may ask the server to increase the length of the next free parking spaces offered. In the second main embodiment of the invention, between the steps 33 and 35, the server performs a step 34 of comparing one or more free parking space lengths and the information representative of the length of the user's vehicle, so as to send the user only free parking space locations whose length is sufficiently greater than the length of the user's vehicle to enable the user to park correctly. The step 35 of sending from the server to the user then comprises only the sending of one or more parking space locations situated in the vicinity of the location specified by the user in his request, without sending any free parking space length.

The image processing step may be performed in three different ways. A first way is for the image processing step to compare images captured by the image capture apparatus over time and one or more reference images corresponding to the parking area when all its parking spaces are free. There may be three reference images, for example, one during the day, the other during the night, and the third at an intermediate time between the daytime and the nighttime. In a second embodiment, the image processing step recognizes the shape of the vehicles occupying the occupied parking spaces in order to determine the free parking spaces. In a third embodiment, the image processing step recognizes motion of vehicles parking in the parking spaces to determine the free parking spaces.

The images are preferably destroyed after processing, and not stored. Thus no memory is necessary in the detection terminal. Moreover, in countries where there is suspicion of anything relating to the intentional or accidental surveillance of privacy, this option should assist to eliminate any doubts.

If the image capture apparatus is situated on the same side of a road as the parking area with which it is associated, the shadows cast on the free parking spaces by the vehicles situated in the occupied parking spaces are essentially shadows depending on the height of the vehicles, since the image capture apparatus is situated virtually on the axis of the line of parking spaces of the parking area. Now, vehicle heights may vary considerably, which renders the processing step more complex. Whereas, in the preferred situation in which, on the one hand, the image capture apparatus and, on the other hand, the parking area associated with the image capture apparatus are situated on respective opposite sides of a road, the shadows cast in the free parking spaces by vehicles situated in the occupied parking spaces are essentially shadows depending on the width of the vehicles, since the image capture apparatus is situated largely off the axis of the line of parking spaces of the parking area. Now, vehicle widths vary much less than their heights, which simplifies the processing step and consequently renders the method of detecting free parking spaces more beneficial.

1. Free parking space detection method comprising:
a step of sending, from a user to a server, a free parking space request specifying a location;
a step of image capture apparatus situated in the vicinity of the specified location capturing one or more images of a parking area comprising a plurality of parking spaces and being associated with the apparatus;
an image processing step to determine respective lengths of free parking spaces in the parking area from one or more images of the parking area;
a step of sending the server an identifier of the image capture apparatus and said respective lengths of said free parking spaces; and
a step of sending, from a server to a user, at least one free parking space location and at least one length associated with said free parking space.

2. Free parking space detection method comprising:
a step of sending, from a user to a server, a free parking space request specifying a location and information representative of a vehicle length;
a step of image capture apparatus situated in the vicinity of the specified location capturing one or more images of a parking area comprising a plurality of parking spaces and being associated with the apparatus;
an image processing step to determine respective lengths of free parking spaces in the parking area from one or more images of the parking area;
a step of sending the server an identifier of the image capture apparatus and said respective lengths of said free parking spaces;
a step of the server comparing, on the one hand, one or more of said respective lengths and, on the other hand, the information representative of a vehicle length, selecting at least one free parking space having a length adapted to said information representative of a vehicle length; and
a step of sending, from a server to a user, at least one selected free parking space location.

3. Parking space detection method according to claim 1, characterized in that the image processing step compares, on the one hand, images captured by the image capture apparatus and, on the other hand, one or more reference images corresponding to the parking area when all its parking spaces are free.

4. Parking space detection method according to claim 1, characterized in that the image processing step determines free parking spaces by recognizing the shapes of vehicles occupying occupied parking spaces.

5. Parking space detection method according to claim 1, characterized in that the image processing step determines free parking spaces by recognizing motion of vehicles parking in the parking spaces.

6. Parking space detection method according to claim 1, characterized in that, on the one hand, the image capture apparatus and, on the other hand, the parking area associated with the image capture apparatus are situated on respective opposite sides of a road.

7. Parking space detection method according to claim 1, characterized in that the images are destroyed after processing and not stored.

8. Free parking space detection terminal comprising:
image capture apparatus associated with a parking area comprising a plurality of parking spaces and adapted to capture images of said parking area; and
a free parking space detection device comprising:
an image processing module adapted to determine from one or more images captured by the image capture apparatus the respective lengths of the free parking spaces in the parking area; and
an interface adapted to send an identifier of the image capture apparatus and said respective lengths of said free parking spaces to a server.

9. Free parking space detection device comprising:
an image processing module adapted to determine from one or more images of a parking area comprising a plurality of parking spaces the respective lengths of the free parking spaces in the parking area; and
an interface adapted to send an identifier of an image capture apparatus that supplied the image or images of the parking area and said respective lengths of said free parking spaces to a server.

10. Free parking space detection terminal comprising:
image capture apparatus associated with a parking area comprising a plurality of parking spaces and adapted to capture images of said parking area; and
a free parking space detection device comprising:
an image processing module adapted to determine from one or more images taken by the image capture apparatus the respective lengths of the free parking spaces in the parking area; and
an interface adapted to send an identifier of the image capture apparatus and said respective lengths of said free parking spaces to the server.

11. Free parking space detection device comprising:
an image processing module adapted to determine from one or more images of a parking area comprising a plurality of parking spaces the respective lengths of the free parking spaces in the parking area; and
an interface adapted to send an identifier of an image capture apparatus that supplied the image or images of the parking area and said respective lengths of said free parking spaces to a server.

12. Free parking space detection server comprising:
a comparison module adapted to compare one or more respective free parking space lengths and information representative of a vehicle length supplied by a user, selecting at least one free parking space having a length adapted to said information representative of a vehicle length; and
an interface adapted to send at least one selected free parking space location to a user.
